(19) United States
(12) Patent Application Publication
(10) Pub. No.: US 2022/0176305 A1
(43) Pub. Date: Jun. 9, 2022

(54) SYSTEM FOR REDUCING FINE DUST

(71) Applicant: NEXTENC, Goyang-si (KR)

(72) Inventor: Dong-Hwan SEO, Seoul (KR)

(21) Appl. No.: 17/599,519

(22) PCT Filed: Dec. 10, 2019
(86) PCT No.: PCT/KR2019/017359

§ 371 Date: Sep. 28, 2021

(30) Foreign Application Priority Data
Apr. 16, 2019 (KR) 10-2019-0044323

(51) Int. Cl. B01D 47/06; B66C 23/18

(52) U.S. Cl. CPC B01D 47/06; B01D 2247/08; B66C 23/18

(57) ABSTRACT

The present invention relates to a system for reducing fine dust floating in the air and, more specifically, to a system for reducing fine dust, the system comprising: a plurality of cranes installed side by side and standing on, for example, a bridge or a riverside; water spray nozzles for obliquely spraying water drop particles up to a height of 80 to 130 m, respectively, from the upper ends of the cranes; water supply means for supplying high-pressure water to the water spray nozzles; and a control unit for controlling each of the cranes, the water spray nozzles, and the water supply means. By forming continuous artificial water walls, having a width of 30 to 60 m and made of the water drop particles sprayed from the water spray nozzles, in a region through which fine dust passes, pleasant living spaces free of fine dust can at least be provided in major living spaces within 40 to 60 m above ground level.

### TECHNICAL FIELD

The present invention relates to a system for reducing fine dust floating in the air and, more specifically, to a system for reducing fine dust, which includes a plurality of cranes installed side by side and standing on, for example, a bridge or a riverside, a water spray nozzle that obliquely spays water drop particles up to a height of 80 to 130 m from a lower end of the crane, a water supply unit that supplies high-pressure water to the water spray nozzle, and a control unit that controls each of the cranes, the water spray nozzle, and the water supply unit, wherein, by forming continuous artificial water walls, which have a width of 30 to 60 m and are made of the water drop particles sprayed from the water spray nozzle, in a region through which fine dust passes, pleasant living spaces free of fine dust are provided in major living spaces within at least 40 to 60 m from the ground.

### BACKGROUND ART

With the development of industrial society, the operations of factories and vehicles using fossil fuels such as coal or petroleum have increased so that the generation of fine particulate materials in the air, that is, fine dust, is significantly increasing. Fine dust, which is only a few micrometers (μm) in size, is not easily removed from the air because of being present in a floating state in the air, and the fine dust travels through the air and spreads over a wide region, causing a number of serious social problems.

In particular, fine dust inhaled into the human body is not filtered through the nose, bronchi, or the like, but penetrates deep into the respiratory tract, causing respiratory diseases such as asthma, bronchitis, and allergic rhinitis, eye diseases such as conjunctivitis and dry eye syndrome, allergic dermatitis, and the like. It is reported that such fine dust is a main culprit of air pollution and threatens the health of modern people and inhibits the growth of animals and plants, as well as causing serious damage to high-tech industries such as semiconductors and the like.

In order to solve the above problems, in the past, preventive measures have been mainly promoted to suppress the generation of fine dust, such as limiting the emission of exhaust gas from factory chimneys or automobiles or limiting an amount of fine dust generated at civil engineering and construction sites. However, there are practical limitations in suppressing the gradual increase in amount of fine dust caused by various generation factors only with these preventive measures.

Therefore, recently, more active efforts are being made to artificially remove fine dust already floating in the air using artificial rainfall or wind, filters, etc. For example, in Korean Patent Registration No. 10-1517906 (registered on Apr. 29, 2015), a fine dust collecting device that collects fine dust by being installed in a mobile means such as a car is disclosed.

The fine dust collecting device removes fine dust floating in the air by allowing the moving means to travel without support of an external power. However, since the cooperation of many people is required to install such a fine dust collecting device in many vehicles, it is less likely to be realized and it is difficult to expect a great effect in removing ultrafine dust in a gaseous state.

Next, in Korean Patent Registration No. 10-1669791 (registered on Oct. 20, 2016), a fine dust reduction device using local and artificial rainfall is disclosed. In order to generate artificial rainfall, the fine dust reduction device has a structure in which a first steel tower and a second steel tower with a height of about 250 to 350 m are installed at an interval of about 4 km and a water spray hose with a spray nozzle and first and second screens for providing a space for forming clouds are installed between the two steel towers.

Further, in Korean Patent Registration No. 10-1915694 (registered on Oct. 31, 2018), a fine dust removal device, in which a large canvas at a certain height from the ground is installed using a balloon or the like and which allows water to flow along a surface of the canvas, thereby adsorbing and removing fine dust that travels while floating in the air on the canvas, is disclosed.

However, these prior fine dust reduction devices or fine dust removal devices require large-scale facilities and huge spaces. Furthermore, because the facilities are very vulnerable to wind, even when the slightest strong wind blows, there is the inconvenience of having to dismantle all the facilities in advance and reinstalling the facilities as necessary.

### DISCLOSURE

### Technical Problem

Generally, fine dust in the air is present in an air layer of the atmosphere, in which the temperature increases as the level of air rises upward, that is, in a temperature inversion layer, and the temperature inversion layer corresponds to a height within about 1 km from the ground. The fine dust is trapped in the temperature inversion layer and cannot move and be diffused into the air, but rather moves horizontally in a certain direction along with the wind, causing living spaces on the ground to be seriously polluted.

However, at the present technical level, it is actually impossible to remove all amount of the fine dust that is widely present in the temperature inversion layer, and even when it is possible to remove all amount of the fine dust, a huge cost will be required. Moreover, since the residential spaces where people mainly live are distributed within 100 m from the ground, and when compressed more, are distributed in a range of 40 to 60 m, removing all amount of the fine dust up to 1 km in height is an inefficient solution.

Accordingly, the present invention is directed to providing a system for reducing fine dust in which, by forming continuous artificial water walls at a predetermined height from the ground in a region through which a large amount of fine dust passes and by removing or reducing the fine dust passing through the corresponding region, a more pleasant air environment with minimum facilities and minimum cost is provided in spaces of at least 40 to 60 m from the ground, which are main living spaces of people.

### Technical Solution

One aspect of the present invention provides a system for reducing fine dust including a plurality of cranes which are each made of a plurality of booms that are allowed to be extended or contracted and which are installed standing up so that angles of the cranes are adjustable and the cranes are rotatable in a state in which lower end portions thereof are fixed; a water spray nozzle which is installed at an upper end of the crane to spray water drop particles up to a height of 80 to 130 m from a lower end of the crane and which includes a plurality of nozzles having different spraying angles and spraying distances of the water drop particles; a water supply unit configured to supply high-pressure water to the water spray nozzle from the lower end of the crane; and a control unit configured to control each of the cranes, the water spray nozzle, and the water supply unit.

In the system for reducing fine dust, the cranes may be consecutively installed side by side at a predetermined interval to form continuous artificial water walls having a width of 30 to 60 m while the water drop particles sprayed from the water spray nozzle fall freely.

### Advantageous Effects

In the system for reducing fine dust according to the present invention, by forming continuous artificial water walls with a height of about 100 m over a section of, for example, several kilometers to several tens of kilometers, in a region through which fine dust passes with the wind, using the water drop particles sprayed from the water spray nozzle, it is possible to secure, in a region located opposite the artificial water walls in a movement direction of wind, pleasant living spaces free from fine dust for main living spaces within at least 40 to 60 m from the ground.

In the system for reducing fine dust according to the present invention, in addition to a unique function of removing fine dust, an urban heat island effect in summer can be suppressed together with an incidental effect of purifying river water, and furthermore, the artificial water walls can be used as a tourist resource by emitting various lights along with a laser on the artificial water walls at night.

### DESCRIPTION OF DRAWINGS

FIG. 1 is a configuration diagram of a system for reducing fine dust according to the present invention.

FIG. 2 is a diagram for describing a state in which artificial water walls are formed by water drop particles (W) sprayed from a water spray nozzle of FIG. 1.

FIG. 3 is a virtual view illustrating a state in which the system for reducing fine dust of the present invention is installed along a bridge.

FIG. 4 is a virtual view illustrating a state in which the system for reducing fine dust of the present invention is installed on a riverside.

### MODES OF THE INVENTION

Hereinafter, the present invention will be described in detail with reference to the accompanying drawings. However, the accompanying drawings illustrate exemplary embodiments of the present invention, and thus the scope of the present invention is not limited by the embodiments of the present invention. In addition, even when components are necessary for embodying the present invention, detailed descriptions of the components that may be introduced in the related art or may be easily performed by those skilled in the art from the known technology will be omitted.

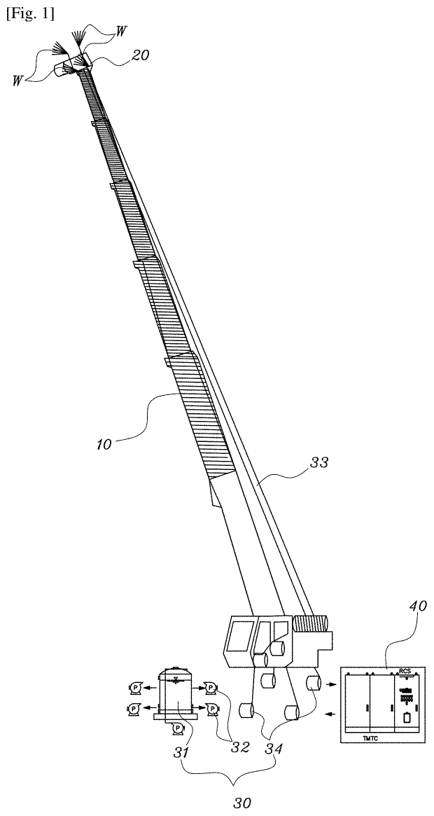

As illustrated in FIG. 1, a system for reducing fine dust according to the present invention includes a plurality of cranes 10 installed standing up to enable height and angle adjustment and rotation, water spray nozzles 20 each installed on an upper end of the crane 10, a water supply unit 30 that supplies high-pressure water to the water spray nozzles 20, and a control unit 40 that controls each of the plurality of cranes 10, the water spray nozzles 20, and the water supply unit 30.

First, the crane 10 has a structure in which a plurality of booms having different diameters are sequentially connected to each other so that an overall length of the booms is extensible or contractible, and the booms having a small diameter may be configured to be sequentially accommodated into the boom having a large diameter. Therefore, when all the booms are extended, the crane 10 has a maximum height of 40 to 60 m and, preferably, 50 to 55 m.

In addition, a length of each of the booms constituting the crane 10 is about 7 m and, in a state in which all the booms are accommodated in a lowermost boom having the largest diameter, the crane 10 may contract to have a height of about 10 m.

Next, the water spray nozzle 20 sprays water drop particles W at the upper end of the crane 10 and sprays the water drop particles W so that the water drop particles W reach a lower end of the crane 10, that is, a spraying height of the water drop particles W becomes a height of 80 to 130 m from the ground. For example, when the height of the crane 10 is 50 m, a water spraying height of the water spray nozzle 20 may range from 30 to 80 m from the upper end of the crane 10. In this case, when the spraying height of the water drop particles W is less than 80 m from the lower end of the crane 10, an effect of removing fine dust is insufficient, and conversely, when the spraying height of the water drop particles W exceeds 130 m, an effect improvement is very low and inefficient due to an increase in operating cost.

Next, the water supply unit 30 may include, for example, a water storage tank 31, high-pressure pumps 32, a transfer hose 33, and hose drums 34.

The water storage tank 31 is a tank for storing water to be sprayed through the water spray nozzles 20, that is, water for spraying, and the water storage tank 31 may be installed near the lower end of the crane 10 and may have a water level control valve installed to maintain a constant water level. The high-pressure pump 32 may be installed next to the water storage tank 31 and function to provide water pressure so that the water for spraying that is stored in the water storage tank 31 is sprayed through the water spray nozzle 20.

Next, the transfer hose 33 functions to transfer the water for spraying that is extruded from the high-pressure pump 32 to the water spray nozzle 20 and may be installed along the booms of the crane 10. The hose drum 34 functions to appropriately adjust a length of the transfer hose 33 by winding or unwinding the transfer hose 33 as the booms of the crane 10 are extended or contracted.

Lastly, the control unit 40 functions to control extension/contraction and an angle of the crane 10, a spraying angle and a spraying distance of the water spray nozzle 20, and each of the high-pressure pumps 32 and the hose drums 34 of the water supply unit 30. In particular, when the cranes 10 are sequentially installed, the cranes 10 are divided into several unit groups, and an integrated operation system may be constructed for each unit group.

According to an exemplary embodiment of the present invention, the cranes 10 may be installed side by side at an interval of 30 to 60 m from each other on a bridge or a riverside. When the cranes 10 are installed on a bridge or a riverside, the water for spraying supplied to the water spray nozzles 20 may be easily secured, the water discharged from the water spray nozzles 20 may return back to the river, and an attendant effect of purifying the water may be obtained.

In this case, since a height, an angle, and rotation of the crane 10 are adjustable while a lower end portion of the crane 10 is fixed, the crane 10 may be easily controlled so that the water discharged from the water spray nozzles 20 falls back to the river in consideration of geographical conditions of the place where the crane 10 is installed, a wind direction and speed at the time of operating the system of the present invention, and the like.

However, preferably, the cranes 10 may spray the water drop particles W in a direction opposite to a direction from which the wind blows while the cranes 10 are each stood up obliquely at an angle of 70 to 85 degrees in the direction opposite to the direction from which the wind blows. This is because, when the water is sprayed in the direction from which the wind blows, the water discharged from the water spray nozzles 20 not only falls onto the water supply unit 30 and the control unit 40 which are installed at the lower end of the crane 10 but also a width of the artificial water walls formed by the water drop particles W is reduced.

In particular, the water discharged from the water spray nozzles 20 may freeze in winter, and thus it is very important to control a water spraying direction so that the water drop particles W fall back into the river. To this end, a wind vane and an anemometer may be installed at the upper end of the crane 10.

When the system for reducing fine dust of the present invention is not operated, all the booms of the crane 10 may be folded and placed side by side on a bridge or a riverside, or the folded booms may be laid side by side to minimize aesthetic resistance.

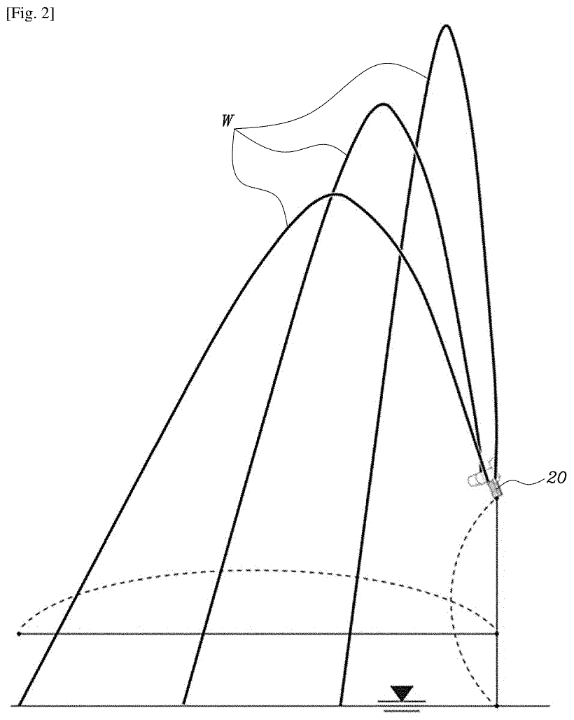

Further, the water spray nozzle 20 may be composed of two to four nozzles having different spraying angles and spraying distances of the water drop particles. As illustrated in FIG. 2, under a condition in which spraying pressures of the water spray nozzles are identical, the spraying distance of the water drop particles is inversely proportional to the spraying angle. That is, as the spraying angle increases, the spraying distance decreases, and as the spraying angle decreases, the spraying distance increases.

According to an embodiment of the present invention, the water spray nozzle 20 may be composed of three nozzles and the water drop particles W sprayed from the water spray nozzle 20 may be configured to form continuous artificial water walls having a width of 30 to 60 m while freely falling. When the width of the artificial water walls is less than 30 m, an effect of removing fine dust may be reduced, and conversely, when the width of the artificial water walls exceeds 60 m, operating costs may be increased.

Meanwhile, an air jet that sprays compressed air may be additionally installed at the upper end of the crane 10. The air jet functions to spray the water drop particles W sprayed from the water spray nozzle 20 in a desired direction according to the wind direction and region and form effective artificial water walls.

Theoretically, when 2.85 tons of water per 1 m² of a ground area is sprayed per day through the water spray nozzle 20, the number of water drop particles W falling within 1 m² of the ground area during one day is changed according to diameters of the water drop particles W as shown in Table 1 below.

TABLE 1

| | Diameter (cm) | | | | | |
|---|---|---|---|---|---|---|
| | 0.5 | 0.3 | 0.2 | 0.1 | 0.05 | 0.02 |
| Number of | 570,240 | 950,400 | 1,425,600 | 2,851,200 | 5,702,400 | 14,256,000 |
| water drops | | | | | | |
| Reference | Heavy rain | Sudden shower | | Normal rain | | Light rain |

As shown in Table 1, as the diameters of the water drop particles W increase, the number of the water drop particles W falling within a unit area decreases, and furthermore, a falling speed increases, and thus the effect of removing fine dust is reduced. However, when the diameters of the water drop particles W are too small, the water drop particles W are blown away due to the wind, and thus effective artificial water walls may not be formed.

Therefore, in the present invention, a degree of distribution of the water drop particles W having a diameter of 0.02 to 0.3 cm among the water drop particles W sprayed through the water spray nozzle 20 may be 80% or more. Further, when the water drop particles W are sprayed through the water spray nozzle 20, a noise protection cap may be detachably installed on the water spray nozzle 20 in order to prevent the generation of noise due to wind noise.

Generally, fine dust is very fine and light, and thus the fine dust sinks at a very slow speed in the air. As a result of theoretically calculating a sinking speed of fine dust in the absence of wind using Stokes' law, it was found that fine dust with a particle size of particulate matter (PM)-2.5 sinks at a speed of 0.82 m per hour and fine dust with a particle size of PM-10 sinks at a speed of 13.1 m per hour.

Therefore, when wind of 1.6 m per second blows, theoretically, PM-10 fine dust sinks by 22.2 m while traveling 10 km and sinks by 66.6 m while traveling 30 km. PM-2.5 fine dust sinks by 1.4 m while traveling 10 km and sinks by 4.2 m while traveling 30 km. However, under natural conditions, due to the influence of wind and updrafts, the fine dust travels long distances while sinking much more slowly.

Accordingly, fine dust generated in China does not fall into the West Sea and continues to flow to Korea. Therefore, for example, in the case in which artificial water walls with a height of about 100 m are formed over several kilometers to several tens of kilometers using the system for reducing fine dust of the present invention in the outskirts of a city where fine dust from China flows through the west wind, it is expected that the fine dust flowing into the corresponding city may be effectively removed for major living spaces within at least 40 to 60 m from the ground and thus a much more pleasant residential environment may be maintained.

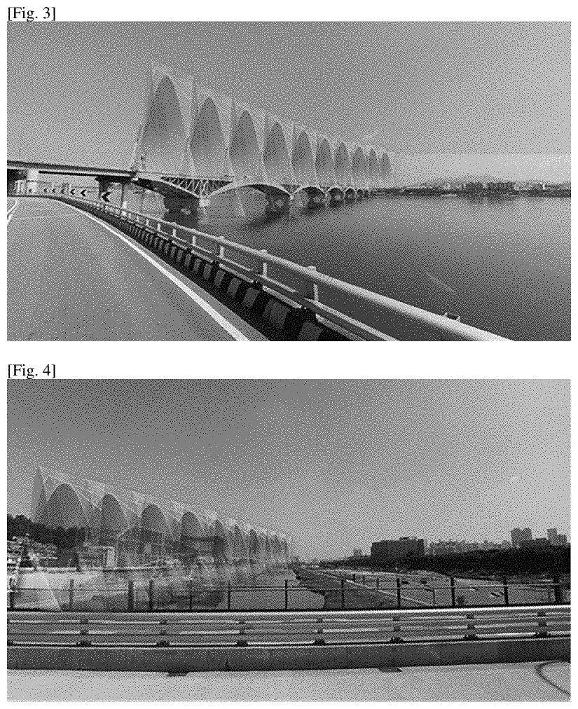

FIG. 3 is a virtual view illustrating a state in which the system for reducing fine dust of the present invention is installed along a bridge, and FIG. 4 is a virtual view illustrating a state in which the system for reducing fine dust of the present invention is installed on a riverside.

As illustrated in FIGS. 3 and 4, in the system for reducing fine dust of the present invention, artificial water walls can be used as a tourist product by installing various lighting lamps on the artificial water walls at night and an additional effect that a local temperature increase due to an urban heat island effect in summer is suppressed can be obtained.

### REFERENCE NUMERALS

10: CRANE
20: WATER SPRAY NOZZLE
30: WATER SUPPLY UNIT
31: WATER STORAGE TANK
32: HIGH-PRESSURE PUMP
33: TRANSFER HOSE
34: HOSE DRUM
40: CONTROL UNIT
W: WATER DROP PARTICLES

1. A system for reducing fine dust, comprising:
a plurality of cranes which are each made of a plurality of booms that are allowed to be extended or contracted and which are installed standing up so that angles of the cranes are adjustable and the cranes are rotatable in a state in which lower end portions thereof are fixed;
a water spray nozzle which is installed at an upper end of the crane to spray water drop particles up to a height of 80 to 130 m from a lower end of the crane and which includes a plurality of nozzles having different spraying angles and spraying distances of the water drop particles;
a water supply unit configured to supply high-pressure water to the water spray nozzle from the lower end of the crane; and
a control unit configured to control each of the cranes, the water spray nozzle, and the water supply unit,
wherein the plurality of cranes are consecutively installed side by side at a predetermined interval to form continuous artificial water walls having a width of 30 to 60 m while the water drop particles sprayed from the water spray nozzle fall freely.

2. The system for reducing fine dust of claim 1, wherein the crane has a maximum height of 40 to 60 m in a state in which all the booms are extended.

3. The system for reducing fine dust of claim 1, wherein the cranes are installed side by side at an interval of 30 to 60 m on a bridge or a riverside.

4. The system for reducing fine dust of claim 1, wherein a degree of distribution of water drop particles having a diameter of 0.02 to 0.3 cm, among the water drop particles sprayed from the water spray nozzle, is 80% or higher.

5. The system for reducing fine dust of claim 1, wherein an air jet that sprays the water drop particles sprayed from the water spray nozzle by spraying compressed air is installed at the upper end of the crane.

6. The system for reducing fine dust of claim 1, wherein the water supply unit includes:
a water storage tank and a high-pressure pump which are installed near the lower end of the crane;
a transfer hose which transfers water extruded from the high-pressure pump to the water spray nozzle and which is installed along the crane; and
a hose drum which is installed near the lower end of the crane and adjusts a length of the transfer hose as the crane is extended and contracted.
